(19) United States
(12) Patent Application Publication
(10) Pub. No.: US 2025/0173459 A1
(43) Pub. Date: May 29, 2025

(54) METHOD AND APPARATUS FOR DE-IDENTIFYING IMAGE DATA

(71) Applicants: HYUNDAI MOTOR COMPANY, Seoul (KR); Kia Corporation, Seoul (KR)

(72) Inventor: Da Ye OH, Suwon-si (KR)

(73) Assignees: HYUNDAI MOTOR COMPANY, Seoul (KR); Kia Corporation, Seoul (KR)

(21) Appl. No.: 18/789,304

(22) Filed: Jul. 30, 2024

(30) Foreign Application Priority Data
Nov. 27, 2023 (KR) 10-2023-0166998

(51) Int. Cl. G06F 21/62; G06T 5/70; G06V 10/25; G06V 20/62; G06V 40/16

(52) U.S. Cl. CPC G06F 21/6254; G06T 5/70; G06V 10/25; G06V 20/625; G06V 40/161; G06V 2201/07

(57) ABSTRACT

A method of de-identifying image data includes receiving, by a receiver, the image data, detecting, by a detector, de-identification areas of objects included in the image data using an artificial intelligence learning model for detecting de-identification areas, and de-identifying, by a de-identifier, the de-identification areas to protect personal information.

### CROSS-REFERENCE TO RELATED APPLICATION

The present application claims priority to Korean Patent Application No. 10-2023-0166998, filed on Nov. 27, 2023, the entire contents of which is incorporated herein for all purposes by this reference.

### BACKGROUND OF THE PRESENT DISCLOSURE

### Field of the Present Disclosure

The present disclosure relates to a technology for de-identifying image data, and more specifically, a method and device for de-identifying image data, which de-identify data for personal information protection from image data collected by a camera of an autonomous vehicle.

### Description of Related art

National personal information protection laws, such as the European General Data Protection Regulation (GDPR) and the California Consumer Privacy Act (CCPA), require de-identifying (or anonymizing) of pedestrian faces and vehicle license plates, which are personal information, when collecting image data from a camera of an autonomous vehicle.

Currently, data is collected in its original form when collecting camera image data from overseas (e.g., Europe and North America) to obtain training data for developing logics that recognize autonomous driving objects and spaces.

However, personal information protection laws may be violated when faces and license plates are not de-identified or anonymized in collecting data from autonomous vehicle cameras.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and device for de-identifying image data, configured for de-identifying data for personal information protection from image data collected by a camera of an autonomous vehicle.

Various aspects of the present disclosure are directed to providing a method and device for de-identifying image data, configured for performing de-identification processing on data requiring personal information protection, such as pedestrian faces and vehicle license plates, which are detected through an AI model for detecting de-identification areas.

Various aspects of the present disclosure are directed to providing a method and device for de-identifying image data, configured for recognizing objects and spaces included in de-identified image data by training a recognition network based on de-identified image data and knowledge distillation.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method of de-identifying image data includes receiving, by a receiver, the image data, detecting, by a detector, de-identification areas of objects included in the image data using an artificial intelligence learning model for detecting de-identification areas, and de-identifying, by a de-identifier, the de-identification areas to protect personal information included in the image data.

According to an exemplary embodiment of the present disclosure, the detecting of the de-identification areas may include detecting, by the detector, a pedestrian face area and a vehicle license plate area included in the image data as the de-identification areas.

According to an exemplary embodiment of the present disclosure, the de-identifying of the de-identification areas may include de-identifying, by the de-identifier, the de-identification areas by blurring the de-identification areas or replacing the de-identification areas with composite images.

According to an exemplary embodiment of the present disclosure, the method may include, in response that a plurality of de-identification areas are detected for each of the objects, determining, by a determiner, a de-identification area for each of the objects by determining a bounding box for the de-identification areas of each of the objects, by use of non-maximum suppression (NMS). The de-identifying of the de-identification areas may include de-identifying, by the de-identifier, the determined de-identification area.

According to an exemplary embodiment of the present disclosure, the image data, in which the de-identification areas are de-identified, may be used as training data of a recognition network for recognizing objects in an autonomous vehicle.

According to an exemplary embodiment of the present disclosure, the recognition network may be trained by a Knowledge Distillation method and the image data, in which the de-identification areas are de-identified.

According to an exemplary embodiment of the present disclosure, the recognition network may be trained based on a loss function including a difference between a result of a teacher network and a result of the recognition network.

According to an aspect of the present disclosure, a method of de-identifying image data includes detecting, by a detector, objects included in the image data using an object detection artificial intelligence model, selecting, by a selector, at least one preset object among the objects, recognizing, by a recognizer, at least a partial area for personal information protection among an area for the at least one object as a de-identification area, and de-identifying, by a de-identifier, the de-identification area.

According to an aspect of the present disclosure, a device for de-identifying image data including a memory containing program instructions and a processor by executing the program instructions. A processor is configured to receive the image data, detect de-identification areas of objects included in the image data using an artificial intelligence learning model for detecting de-identification areas, and a de-identify the de-identification areas for personal information protection.

According to an exemplary embodiment of the present disclosure, the processor may detect a pedestrian face area and a vehicle license plate area included in the image data as the de-identification area.

According to an exemplary embodiment of the present disclosure, the processor may de-identify the de-identification area by blurring the de-identification area or replacing the de-identification area with a composite image.

According to an exemplary embodiment of the present disclosure, wherein the processor may be further configured to determine a de-identification area for each of the objects by determining a bounding box for the de-identification areas of each of the objects, by use of non-maximum suppression (NMS), in response that a plurality of de-identification areas are detected for each of the objects, and de-identify the determined de-identification area.

According to an exemplary embodiment of the present disclosure, the image data, in which the de-identification areas are de-identified, may be used as training data of a recognition network for recognizing objects in an autonomous vehicle.

According to an exemplary embodiment of the present disclosure, the recognition network may be trained by a Knowledge Distillation method and the image data, in which the de-identification areas are de-identified.

According to an exemplary embodiment of the present disclosure, the recognition network may be trained based on a loss function including a difference between a result of a teacher network and a result of the recognition network.

According to an exemplary embodiment of the present disclosure, the processor is further configured to select at least one preset object among the objects, recognize at least a partial area for the personal information protection among an area for at least one object among the objects as a de-identification area, and de-identify the de-identification area.

The features briefly summarized above for the present disclosure are only illustrative aspects of the detailed description of the present disclosure that follows, but do not limit the scope of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates an operational flowchart of a method of de-identifying image data according to an exemplary embodiment of the present disclosure;

FIG. 2A, FIG. 2B and FIG. 2C illustrate example diagrams for describing a process of detecting a de-identification area from image data;

FIG. 3A and FIG. 3B illustrate examples in which a detected de-identification area is de-identified by blurring;

FIG. 4 illustrates an operational flowchart for recognition network training and object/space recognition using de-identified image data.

FIG. 5 illustrates an example diagram for describing recognition network training;

FIG. 6 illustrates a block diagram of a device for de-identifying image data according to another exemplary embodiment of the present disclosure; and

FIG. 7 illustrates a block diagram of a computing system for executing a method for de-identifying image data according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the accompanying drawings, various exemplary embodiments of the present disclosure will be described in detail so that those of ordinary skill in the art may easily carry out the present disclosure. However, the present disclosure may be embodied in several different forms and is not limited to the exemplary embodiments described herein.

In describing the exemplary embodiments of the present disclosure, when it is determined that a detailed description of a known configuration or function may obscure the gist of the present disclosure, a detailed description thereof will be omitted. In the drawings, parts not related to the description are omitted, and like reference numerals refer to like elements throughout the specification.

In an exemplary embodiment of the present disclosure, it will be understood that when an element is referred to as being “connected to”, “coupled to”, or “combined with” another element, the element may be directly connected or coupled to or combined with the another element or intervening elements may be present therebetween. It will be further understood that the terms “comprise”, “include” or “have” when used in an exemplary embodiment of the present disclosure specify the presence of stated elements but do not preclude the presence or addition of one or more other elements.

In an exemplary embodiment of the present disclosure, terms such as first and second are used only for distinguishing one element from other elements, and do not limit the order or importance of the elements unless specifically mentioned. Therefore, within the scope of the present disclosure, a first element in various exemplary embodiments of the present disclosure may be referred to as a second element in another exemplary embodiment of the present disclosure, and similarly, the second element in various exemplary embodiments of the present disclosure may be referred to as the first element in another exemplary embodiment of the present disclosure.

In an exemplary embodiment of the present disclosure, distinct elements are only for clearly describing their features, and do not mean that the elements are separated necessarily. That is, a plurality of elements may be integrated to form a single hardware or software unit, or a single element may be distributed to form a plurality of hardware or software units. Accordingly, such integrated or distributed embodiments are included in the scope of the present disclosure, even when not otherwise noted.

In an exemplary embodiment of the present disclosure, elements described in the various exemplary embodiments of the present disclosure are not necessarily essential elements, and some elements may be optional. Accordingly, various exemplary embodiments including a subset of the elements described in an exemplary embodiment are also included in the scope of the present disclosure. Furthermore, various exemplary embodiments including other elements in addition to the elements described in the various exemplary embodiments of the present disclosure are also within the scope of the present disclosure.

In an exemplary embodiment of the present disclosure, expressions of positional relationships used in the specification, such as top, bottom, left, or right, are described for convenience of description, and when the drawings shown in the specification are viewed in reverse, the positional relationships described in the specification may also be interpreted in the opposite way.

In an exemplary embodiment of the present disclosure, each of the phrases “A or B,” “at least one of A and B,” “at least one of A or B,” “A, B, or C,” “at least one of A, B, and C,” and “at least one of A, B, or C” may include any one of items listed along with a relevant phrase, or any possible combination thereof.

Embodiments of the present disclosure may aim to de-identify data for personal information protection from image data collected by an autonomous vehicle camera, and train a recognition network based on the de-identified image data and Knowledge Distillation to eliminate recognition performance issues which may arise in recognizing objects and spaces contained in de-identified image data.

In other words, various exemplary embodiments of the present disclosure may de-identify pedestrian faces, vehicle license plates, and the like for personal information protection from image data and solves the problem of degradation of object and space recognition which may be caused by de-identification through a recognition network trained based on de-identified image data and knowledge distillation, thus recognizing objects and spaces from the de-identified image data without affecting the performance of recognition for the de-identified objects and spaces.

In various exemplary embodiments of the present disclosure, various exemplary embodiments of the present disclosure may detect de-identification areas for personal information protection using an artificial intelligence learning model that receives image data as input thereof, and de-identify the de-identification areas by blurring the de-identification areas or replacing the de-identification areas with composite images through DeepFake or the like.

In various exemplary embodiments of the present disclosure, when a plurality of de-identification areas are detected by an artificial intelligence learning model, for example, when a plurality of de-identification areas are detected by an artificial intelligence learning model such as YOLO, various exemplary embodiments of the present disclosure may determine each de-identification area by determining a bounding box for each of the de-identification areas using NMS (Non-maximum Suppression), and then de-identify the determined de-identification area.

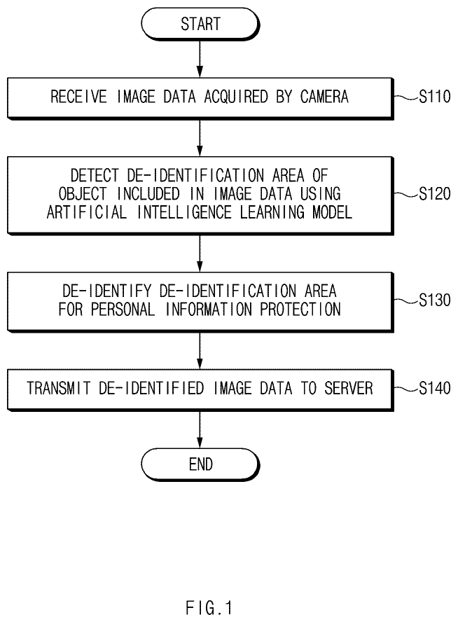

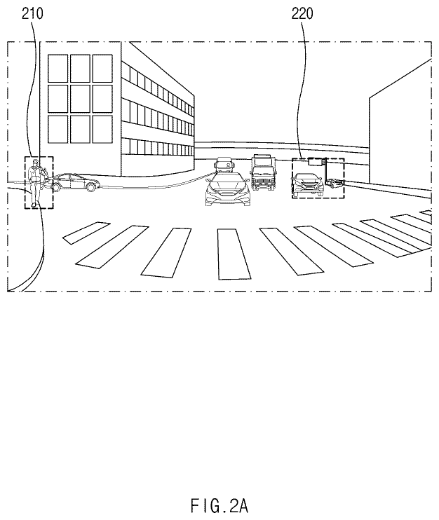

A method and a device for de-identifying image data according to an exemplary embodiment of the present disclosure will be described with reference to FIGS. 1 to 6.

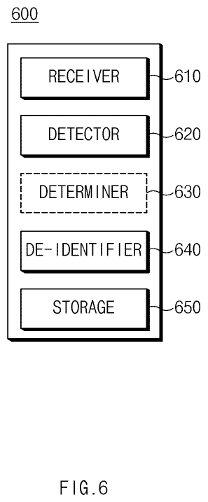

Device for de-identifying image data may include a memory for storing a program instruction, and a processor configured to execute the program instruction. Receiver (610 of FIG. 6), detector (620 of FIG. 6), de-identifier (640 of FIG. 6), determiner (630 of FIG. 6) may perform a related function through the processor included in the device for de-identifying.

FIG. 1 is an operational flowchart for a method of de-identifying image data according to an exemplary embodiment of the present disclosure.

Referring to FIG. 1, a method of de-identifying image data according to an exemplary embodiment of the present disclosure may include receiving, by a receiver (610 of FIG. 6), image data captured and obtained by image capturing means, such as a camera attached to a vehicle and detecting, by a detector (620 of FIG. 6) a de-identification area of an object included in the image data using an artificial intelligence (AI) learning model trained to detect a preset de-identification area (S110 and S120).

According to an exemplary embodiment of the present disclosure, the AI learning model may be a deep learning-based learning model, and may be trained using de-identification areas, such as pedestrian faces and vehicle license plates that require personal information protection, as training data.

For example, the training data for training the AI learning model may include original image data input from a camera of a vehicle obtaining image data and label data in which areas corresponding to pedestrian faces and vehicle license plates, which are objects to be recognized, are obtained as (x, y) coordinate values in a form of a bounding box.

The AI learning model may use a YOLO-based object detection deep learning model, and may learn the positions of objects such as pedestrian faces and vehicle license plates, for example, de-identification areas to be recognized, as training data. In the instant case, the input size of image data input to the AI learning model and the output size of output data may be identical, for example, the training data may be resized to a size of 1280×1280 and the AI learning model may be trained using the resized training data. Of course, in the instant case, the output size of the output from the AI learning model may also be 1280×1280.

The output of the AI learning model may be output as the coordinate values (x1, y1), (x2, y2) of the bounding box of a de-identification area including objects to be de-identified, such as faces and vehicle license plates.

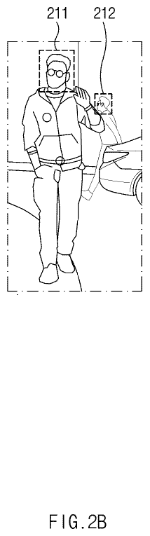

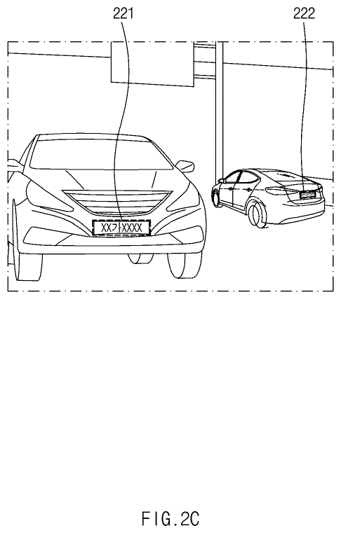

For example, when the image data shown in FIG. 2A is input to the AI learning model trained on the de-identification areas, pedestrian faces 211 and 212 and vehicle license plates 221, 222 may be detected as the de-identification areas from a pedestrian 210 and a vehicle 220 included in the image data, as shown in FIG. 2B and FIG. 2C. It should be noted that the image data in FIG. 2A includes other vehicle license plates, but for ease of description, only some of the vehicle license plates are illustrated in the de-identification areas in FIG. 2C.

When the de-identification areas included in the image data, such as pedestrian faces and vehicle license plates, are detected through the process as described above, the detected de-identification areas may be de-identified for privacy protection by a de-identifier (640 in FIG. 6), and the de-identified image data may be used as training data for training the object and spatial recognition network by sending or uploading the image data, on which de-identification has been performed, to a server (S130 and S140). The de-identified image data may be transmitted to a server. The server may receive the de-identified image data from the image data de-identification device. The server may store the received de-identified image data. The server may transmit the received de-identified image data to another electronic device.

According to an exemplary embodiment of the present disclosure, the method may include performing, by a determiner (630 in FIG. 6), a post-processing to determine one of a plurality of bounding boxes for the de-identification areas, that is, the pedestrian faces or vehicle license plates, and de-identifying, by the de-identifier (640 in FIG. 6), one bounding box determined for the pedestrian face or the vehicle license plate, because the plurality of bounding boxes are detected for each de-identification area when there are multiple de-identification areas detected in S130, for example, when the AI learning model is a YOLO-based learning model.

According to an exemplary embodiment of the present disclosure, the method may include determining, by the determiner (630 of FIG. 6), one of the plurality of bounding boxes for each of the de-identification areas using non-maximum suppression (NMS).

The non-maximum suppression (NMS) may be configured to determine a bounding method of one of the plurality of bounding boxes for the same de-identification area by removing remaining bounding boxes, except only one bounding box with the highest score or confidence score among multiple bounding boxes for the same de-identification area and also removing bounding boxes that do not satisfy an intersection over union (IOU) threshold, for coordinate values of a plurality of bounding boxes output by the AI learning model.

According to an exemplary embodiment of the present disclosure, in S130, the de-identifier (640 in FIG. 6) may de-identify the de-identification area (by blurring the de-identification area or replacing the de-identification area with a composite image through DeepFake technique.

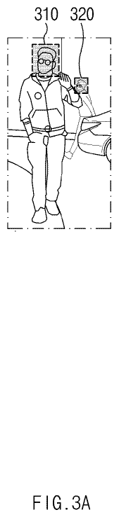

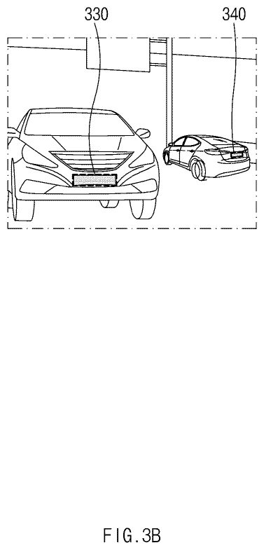

In one example, in S130, as shown in FIG. 3A and FIG. 3B, the de-identification areas 211, 212, 221, and 222 (FIG. 2) detected as pedestrian faces or vehicle license plates may be subjected to blurring processing through a blurring technique such as Average blur or Gaussian blur which are OpenCV Blur techniques to generate and obtain blurred pedestrian faces 310 and 320 and blurred vehicle license plates 330 and 340.

In another example, in S130, the de-identifier (640 in FIG. 6) may replace the de-identification areas 211, 212, 221, and 222 (FIG. 2) detected as pedestrian faces or vehicle license plates with composite images or generate the composite images through a DeepFake technique using a Generative Adversarial Network (GAN)-based model to de-identify the de-identification areas.

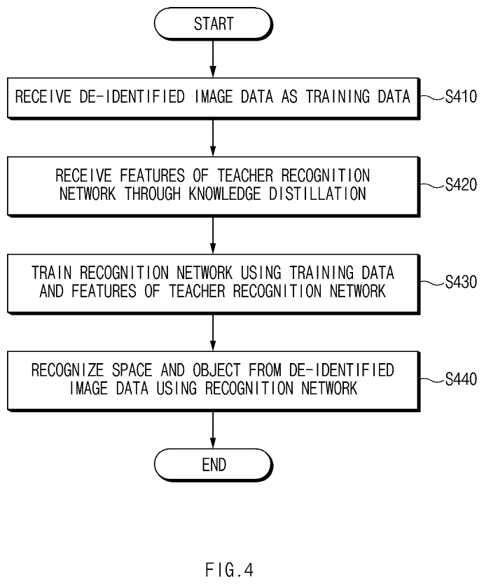

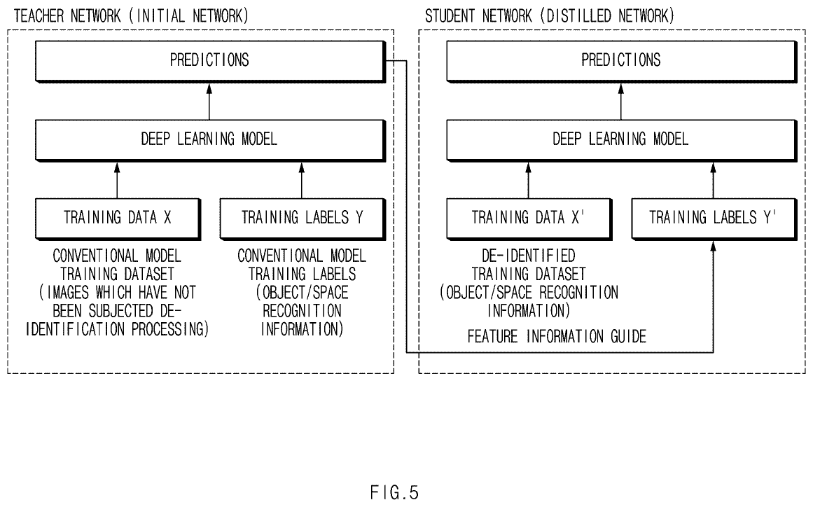

It may be required to train a recognition network for recognizing objects and spaces using image data de-identified through the process of FIG. 1 and to recognize the objects and the spaces from the image data in which the de-identification areas are de-identified using the trained recognition network. However, de-identification may affect the performance of recognition of recognizing objects and spaces from de-identified image data, and therefore, a method that does not affect recognition performance is needed, which will be described with reference to FIG. 4 and FIG. 5.

FIG. 4 is a flowchart of operations for training a recognition network and recognizing objects/spaces using de-identified image data, which shows a flowchart of operations for training a recognition network using de-identified image data by the method of FIG. 1, FIG. 2A, FIG. 2B and FIG. 2C, and FIG. 3A and FIG. 3B, and recognizing objects and spaces from the de-identified image data using the trained recognition network.

Referring to FIG. 4, a method according to an exemplary embodiment of the present disclosure may include receiving, by a receiver, de-identified image data obtained or generated through the process of FIG. 1, that is, de-identified image data, in which de-identification areas such as pedestrian faces and vehicle license plates have been subjected to de-identification processing, to train the recognition network and receiving, by the receiver, features of a teacher recognition network through knowledge distillation.

Accordingly, the recognition network may be trained by a training device using the training data received in S410, that is, the de-identified training data, and the features received from the teacher recognition network in S420 (S430).

For example, as shown in FIG. 5, the teacher network may transfer, to a recognition network (student network), features from a deep learning model trained with existing model training datasets (images which have not been subjected de-identification processing) and the existing model training labels (object/space recognition information). The recognition network (student network), which trains a model with the de-identified training datasets, may train the model with the features received from the teacher network together, having no significant influence on the object/space recognition performance even though some identification information related to pedestrian faces and vehicle license plates has disappeared from in the image data.

In the instant case, the recognition network (student network) may be trained to mimic the teacher network after a difference between the results of the teacher network and the recognition network (student network) is included in the loss function.

When the recognition network (student network) is trained with the training data including the features of the teacher network and the de-identified image data in S430, a recognition device may recognize spaces and objects from the de-identified image data input to the recognition network by use of the trained recognition network S440.

In the instant case, S440 may be a phase performed only with the recognition network trained by the process of S410 to S430 described above, in which the recognition network recognizes objects and spaces from the de-identified image data in real time by inputting the de-identified image data to the recognition network, which has been trained in advance, after the image data obtained by the camera of an autonomous vehicle has been de-identified through the process of FIG. 1.

In other words, in S440, objects and spaces may be to accurately recognized from the de-identified image data in real time by providing de-identification areas as an input to the recognition network after the de-identification areas have been de-identified in real time through the process of S110 to S130 of FIG. 1.

Thus, the method of de-identifying image data according to an exemplary embodiment of the present disclosure and the recognition method thereof may include de-identifying data which requires personal information protection from image data collected by a camera of an autonomous vehicle, and training the recognition network based on the de-identified image data and Knowledge Distillation to recognize objects and spaces from the de-identified image data.

Furthermore, the method of de-identifying image data according to an exemplary embodiment of the present disclosure may include performing de-identification processing on data requiring personal information protection, such as pedestrian faces and vehicle license plates, which are detected through an AI model for detecting de-identification areas, thus preventing violation of personal information protection laws when collecting image data.

Furthermore, a method of recognizing de-identified image data according to an exemplary embodiment of the present disclosure may include recognizing objects and spaces from the de-identified image data obtained in real time using a recognition network trained based on a training dataset of the de-identified image data and knowledge distillation using a teacher network after image data obtained by the camera of the autonomous vehicle has been de-identified.

The method according to various exemplary embodiments of the present disclosure is not limited or restricted to de-identifying image data obtained from a camera of a foreign autonomous vehicle, and may also de-identify image data obtained from a camera of a domestic vehicle. Of course, when the recognition network is applied to the vehicle, the autonomous vehicle may combine the de-identification method according to an exemplary embodiment of the present disclosure with the recognition network to de-identify image data obtained from the camera of the autonomous vehicle in real time, and then recognize objects and spaces from the de-identified image data in real time by use of the recognition network.

When image data obtained by the camera of a foreign autonomous vehicle is de-identified and then provided to a domestic server, the method of the present disclosure may include the following processor. For example, when camera image data is first obtained from the autonomous vehicle that has obtained the data, data curation is performed based on an acquisition scenario, the curated data is de-identified by the method of the present disclosure, and the de-identified image data is uploaded to the server after de-identification. As described with reference to FIG. 1, in the de-identification processing, input image may be scaled to fit the input size of the AI learning model, de-identification areas such as pedestrian faces and vehicle license plates may be detected through the AI learning model. Thereafter, the detected de-identification areas, that is, bounding boxes, may be post-processed to determine one bounding box for each de-identified object, and de-identified through blurring, DeepFake or the like to de-identify pedestrian faces and vehicle license plates that require privacy protection. The method of de-identifying image data according to an exemplary embodiment of the present disclosure may include finally outputting the de-identified image data that has been processed as described above.

Furthermore, the method of de-identifying image data described with reference to FIG. 1 may include immediately detecting a de-identification area from image data using an AI learning model and then de-identifying the detected de-identification area. Alternatively, the method of de-identifying image data may include detecting the de-identification area by combining a conventional object detection learning model that detects objects such as pedestrians and vehicles and a de-identification area detection learning model that detects only a de-identification area from an object detected by the object detection learning model. For example, the method of de-identifying image data according to another exemplary embodiment of the present disclosure may include detecting, by a detector, objects included in image data using an object detection AI model, and selecting by a selector, at least one preset object, such as a pedestrian and a vehicle, among the detected objects, recognizing, by a recognition device, at least a partial area for personal information protection among an area for the selected at least one object, a pedestrian face or vehicle license plate as a de-identification area, and performing, by a de-identifier, de-identification on a de-identification area included in the image data by de-identifying the recognized de-identification area.

In an exemplary embodiment of the present disclosure, the selector, the recognition device and the de-identifier may be implemented with a processor.

FIG. 6 is a block diagram of a device for de-identifying image data according to another exemplary embodiment of the present disclosure, and is a block diagram of a configuration of a device performing the method of FIG. 1, FIG. 2A, FIG. 2B and FIG. 2C, FIG. 3A and FIG. 3B, FIG. 4, and FIG. 5.

Referring to FIG. 6, a device for de-identifying image data 600 according to another exemplary embodiment of the present disclosure may include a receiver 610, a detector 620, a determiner 630, a de-identifier 640, and storage 650.

The storage 650 is a means for storing various data related to the technology of the present disclosure, and may store information such as image data captured by a camera, an artificial intelligence learning model for detecting de-identification areas, a recognition network or recognition model for recognizing an object and a space, and de-identified image data. It should be noted that the storage may store any information related to the technology of the present disclosure. The storage 650 may be referred to memory.

The receiver 610 may receive image data obtained by a vehicle camera.

The detector 620 may detect de-identification areas of an object included in the image data, such as a pedestrian face and a vehicle license plate, using an AI learning model for detecting de-identification areas. The detector 620 may include an AI learning model trained to detect de-identification areas. The detector 620 may be implemented with a processor.

The determiner 630 may be a component required when a plurality of de-identification areas of each of objects detected by the detector 620 are detected and may be configured to determine a de-identification area of each object by determining a bounding box for the de-identification areas of each object using non-maximum suppression (NMS) when a plurality of de-identification areas are detected for each object.

According to an exemplary embodiment of the present disclosure, the determiner 630 may be configured to determine a bounding method of one of the plurality of bounding boxes for the same de-identification area by removing remaining bounding boxes, except only one bounding box with the highest score or confidence score among multiple bounding boxes for the same de-identification area and also removing bounding boxes that do not satisfy an intersection over union (IOU) threshold, for coordinate values of a plurality of bounding boxes output by the AI learning model.

The de-identifier 640 may de-identify de-identification areas detected by the detector 620 or the de-identification area determined by the determiner 630.

According to an exemplary embodiment of the present disclosure, the de-identifier 640 may de-identify the de-identification area by blurring the de-identification area or replacing the de-identification area with a composite image, through a deep fake technique.

According to an exemplary embodiment of the present disclosure, the de-identifier 640 may transmit or upload the de-identified image data to a server. The de-identified image data may be transmitted to a server. The server may receive the de-identified image data from the image data de-identification device. The server may store the received de-identified image data. The server may transmit the received de-identified image data to another electronic device.

In an exemplary embodiment of the present disclosure, the receiver 610, the determiner 630 and the de-identifier 640 may be implemented with a processor.

Although not shown, the device according to other embodiments of the present disclosure may include a recognition network for recognizing objects and spaces from de-identified image data, wherein the recognition network may be trained using a training dataset of the de-identified image data and features of a teacher network received from the teacher network through knowledge distillation.

According to the embodiments, the recognition network may be trained to imitate the teacher network by including a difference between result of the teacher network and result of the recognition network in a loss function.

Even when a description is omitted in the apparatus according to another exemplary embodiment of the present disclosure, the apparatus according to another exemplary embodiment of the present disclosure may include all of the contents described in the methods of FIG. 1, FIG. 2A, FIG. 2B and FIG. 2C, FIG. 3A and FIG. 3B, FIG. 4, and FIG. 5, which is obvious to those skilled in the art.

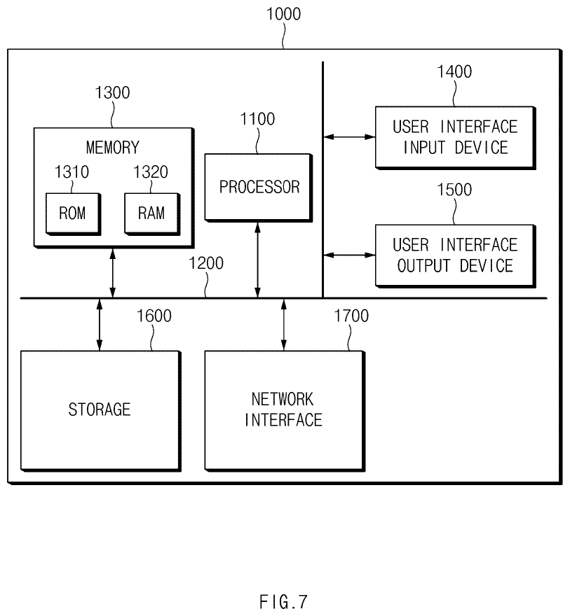

FIG. 7 is a block diagram of a computing system for performing a method of de-identifying image data according to an exemplary embodiment of the present disclosure.

Referring to FIG. 7, the device for de-identifying image data according to the exemplary embodiment of the present disclosure described above may be implemented through the computing system. A computing system 1000 may include at least one processor 1100, a memory 1300, a user interface input device 1400, a user interface output device 1500, storage 1600, and a network interface 1700, which are connected to each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains. Accordingly, the exemplary embodiment included in an exemplary embodiment of the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

According to an exemplary embodiment of the present disclosure, it is possible to de-identify data for personal information protection in image data collected by a camera of an autonomous vehicle.

According to an exemplary embodiment of the present disclosure, it is possible to prevent violation of personal information protection laws in collecting image data, by performing de-identification processing on data requiring personal information protection, such as pedestrian faces and vehicle license plates, which are detected through an AI model for detecting de-identification areas.

According to an exemplary embodiment of the present disclosure, it is possible to recognize objects and spaces included in de-identified image data by training a recognition network based on de-identified image data and knowledge distillation.

The effects obtainable in an exemplary embodiment of the present disclosure are not limited to the aforementioned effects, and any other effects not mentioned herein will be clearly understood from the following description by those skilled in the art to which the present disclosure pertains.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of de-identifying image data, the method comprising:
receiving, by a receiver, the image data;
detecting, by a detector, de-identification areas of objects included in the image data using an artificial intelligence learning model for detecting de-identification areas; and
de-identifying, by a de-identifier, the de-identification areas to protect personal information included in the image data.

2. The method of claim 1, wherein the detecting of the de-identification areas includes detecting, by the detector, a pedestrian face area and a vehicle license plate area included in the image data as the de-identification areas.

3. The method of claim 1, wherein the de-identifying of the de-identification areas includes de-identifying, by the de-identifier, the de-identification areas by blurring the de-identification areas or replacing the de-identification areas with composite images.

4. The method of claim 1, further including:
in response that a plurality of de-identification areas are detected for each of the objects, determining, by a determiner, a de-identification area for each of the objects by determining a bounding box for the de-identification areas of each of the objects, by use of non-maximum suppression (NMS),
wherein the de-identifying of the de-identification areas includes de-identifying, by the de-identifier, the determined de-identification area.

5. The method of claim 1, wherein the image data, in which the de-identification areas are de-identified, is used as training data of a recognition network for recognizing objects in an autonomous vehicle.

6. The method of claim 5, wherein the recognition network is trained by a Knowledge Distillation method and the image data, in which the de-identification areas are de-identified.

7. The method of claim 6, wherein the recognition network is trained based on a loss function including a difference between a result of a teacher network and a result of the recognition network.

8. A method of de-identifying image data, the method comprising:
detecting, by a detector, objects included in the image data using an object detection artificial intelligence model;
selecting, by a selector, at least one preset object among the objects;
recognizing, by a recognizer, at least a partial area for personal information protection among an area for the at least one object as a de-identification area; and
de-identifying, by a de-identifier, the de-identification area.

9. An apparatus for de-identifying image data, the apparatus comprising:
a memory containing program instructions; and
a processor,
wherein the processor, by executing the program instructions, is configured to:
receive the image data;
detect de-identification areas of objects included in the image data using an artificial intelligence learning model for detecting de-identification areas; and
de-identify the de-identification areas for personal information protection.

10. The apparatus of claim 9, wherein the processor is further configured to detect a pedestrian face area and a vehicle license plate area included in the image data as the de-identification area.

11. The apparatus of claim 9, wherein the processor is further configured to de-identify the de-identification area by blurring the de-identification area or replacing the de-identification area with a composite image.

12. The apparatus of claim 9, wherein the processor is further configured to:
determine a de-identification area for each of the objects by determining a bounding box for the de-identification areas of each of the objects, by use of non-maximum suppression (NMS), in response that a plurality of de-identification areas are detected for each of the objects, and
de-identify the determined de-identification area.

13. The apparatus of claim 9, wherein the image data, in which the de-identification areas are de-identified, is used as training data of a recognition network for recognizing objects in an autonomous vehicle.

14. The apparatus of claim 13, wherein the recognition network is trained by a Knowledge Distillation method and the image data, in which the de-identification areas are de-identified.

15. The apparatus of claim 14, wherein the recognition network is trained based on a loss function including a difference between a result of a teacher network and a result of the recognition network.

16. The apparatus of claim 9, wherein the processor is further configured to:
selecting at least one preset object among the objects;
recognizing at least a partial area for the personal information protection among an area for at least one object among the objects as a de-identification area; and
de-identifying the de-identification area.
